(19) United States
(12) Patent Application Publication
(10) Pub. No.: US 2020/0327317 A1
(43) Pub. Date: Oct. 15, 2020

(54) UNMANNED AUTONOMOUS VEHICLE AND METHOD OF CONTROLLING THE SAME

(71) Applicants: Hyundai Motor Company, Seoul (KR); Kia Motors Corporation, Seoul (KR)

(72) Inventor: Jiyong Park, Cheonan (KR)

(21) Appl. No.: 16/597,350

(22) Filed: Oct. 9, 2019

(30) Foreign Application Priority Data
Apr. 9, 2019 (KR) 10-2019-0041353

(51) Int. Cl. G06K 9/00; G05D 1/02; B62D 47/02; B60W 40/08

(52) U.S. Cl. CPC G06K 9/00436; G05D 1/021; G06K 9/00778; B60W 2300/10; B60W 40/08; G06K 9/00335; B62D 47/02

(57) ABSTRACT

An unmanned autonomous vehicle and method of controlling the same are provided. The method includes acquiring a boarding intention of a passenger who intends to board the unmanned autonomous vehicle and determining whether to stop the unmanned autonomous vehicle at a bus stop based on the acquired boarding intention of the unmanned autonomous vehicle.

### CROSS-REFERENCE TO RELATED APPLICATION(S)

This application is based on and claims priority under 35 U.S.C. § 119 to Korean Patent Application No. KR10-2019-0041353, filed on Apr. 9, 2019, the disclosure of which is incorporated herein by reference.

### BACKGROUND

### 1. Technical Field

The present invention relates to unmanned autonomous vehicles, and more particularly, to unmanned autonomous vehicles for passengers or cargo via a specific location while traveling along a predetermined route from an origin to a destination.

### 2. Description of the Related Art

While driving, an autonomous vehicle acquires and processes external information to detect a surrounding environment, determines a driving route, and operates the vehicle independently using self-power. In other words, the autonomous vehicle, using maps, satellite navigation systems (GPS), and various sensors, is capable of detecting the surrounding environment and determining the route to travel along the route by manipulating a steering wheel, accelerator, brake, etc. An implementation of the autonomous vehicle requires a variety of automatic control technologies such as distance maintenance, lane departure warning, lane keeping assistance, rear/side warning, cruise control and automatic emergency braking.

For the autonomous vehicle, the term ‘autonomous vehicle’ is used for both a manned vehicle and an unmanned vehicle. However, a vehicle that performs all the decisions and controls necessary for driving without a driver, is specifically referred to as ‘an unmanned autonomous vehicle’ or ‘a driverless autonomous vehicle.’ A subject of driving of the manned autonomous vehicle may be the vehicle itself or the driver. In contrast, a subject of driving of the unmanned autonomous vehicle is the vehicle itself due to an absence of the driver.

In using such conventional unmanned autonomous vehicles, there is no suitable way for passengers who desire to board the unmanned autonomous vehicle to communicate their intent to the unmanned autonomous vehicle at a bus stop (or bus station).

### SUMMARY

According to an aspect of the present invention, an object of the present invention is to enable passengers waiting at a bus stop (or bus station) to show or transmit boarding intentions of the passengers to board an unmanned autonomous vehicle.

It is an aspect of the present invention to provide a method of controlling an unmanned autonomous vehicle that may include: acquiring a boarding intention of a passenger who intends to board the unmanned autonomous vehicle; and determining whether to stop the unmanned autonomous vehicle at a bus stop based on the acquired boarding intention of the unmanned autonomous vehicle.

The acquiring of the boarding intention may include: photographing the bus stop using a camera; and determining that the passenger indicates the boarding intention of the unmanned autonomous vehicle when a predetermined indication of the boarding intention is included in a photographed image. The predetermined indication of the boarding intention may include the passenger making a predetermined gesture to indicate the boarding intention; and the unmanned autonomous vehicle may be configured to verify the boarding intention by capturing the gesture of the passenger using the camera.

The predetermined indication of the boarding intention may include operating a button provided at the bus stop to turn on an indicator linked to the button; and the unmanned autonomous vehicle may be configured to photograph the indicator by the camera and verify the boarding intention based on whether the indicator is turned on. The acquiring of the boarding intention may include: receiving a wireless communication signal generated in response to the boarding intention of the passenger; and determining that the passenger indicates the boarding intention of the unmanned autonomous vehicle when a predetermined indication of the boarding intention is included in the wireless communication signal.

The indication of the boarding intention of the passenger may include inputting the boarding intention through a touch display provided at the bus stop; and the unmanned autonomous vehicle may be configured to verify the boarding intention by receiving the input of the touch display via wireless communication. The indication of the boarding intention of the passenger may further include inputting the boarding intention via a mobile device; and the unmanned autonomous vehicle may be configured to verify the boarding intention by receiving the input of the mobile device via wireless communication.

It is another aspect of the present invention to provide an unmanned autonomous vehicle that may include: an acquiring device configured to acquire a boarding intention of a passenger intending to board the unmanned autonomous vehicle; and a controller configured to determine whether to stop the unmanned autonomous vehicle at a bus stop based on the acquired boarding intention of the unmanned autonomous vehicle.

The acquiring device may include a camera configured to capture or photograph an image of the next bus stop; and the controller may be configured to determine that the passenger indicates the boarding intention of the unmanned autonomous vehicle when a predetermined indication of the boarding intention is included in a photographed image. The predetermined indication of the boarding intention may include the passenger making a predetermined gesture to indicate the boarding intention; and the unmanned autonomous vehicle may be configured to verify the boarding intention by photographing the gesture of the passenger using the camera.

The predetermined indication of the boarding intention may also include operating a button provided at the bus stop to turn on an indicator linked to the button; and the unmanned autonomous vehicle may be configured to photograph the indicator by the camera and verify the boarding intention based on whether the indicator is turned on. The acquiring of the boarding intention may include: receiving a wireless communication signal generated in response to the boarding intention of the passenger; and determining that the passenger indicates the boarding intention of the unmanned autonomous vehicle when a predetermined indication of the boarding intention is included in the wireless communication signal.

Additionally, the indication of the boarding intention of the passenger may include inputting the boarding intention through a touch display provided at the bus stop; and the unmanned autonomous vehicle verifies the boarding intention by receiving the input of the touch display via wireless communication. The indication of the boarding intention of the passenger may also include inputting the boarding intention via a mobile device; and the unmanned autonomous vehicle may be configured to verify the boarding intention by receiving the input of the mobile device via wireless communication.

It is yet another aspect of the present invention to provide a method of controlling an unmanned autonomous vehicle that may include: acquiring, by an acquiring device, a boarding intention of a passenger who intends to board the unmanned autonomous vehicle by photographing a bus stop using a camera; determining, by a controller, that the passenger indicates the boarding intention of the unmanned autonomous vehicle when a predetermined indication of the boarding intention is included in a photographed image; and determining, by the controller, whether to stop the unmanned autonomous vehicle at the bus stop based on the acquired boarding intention of the unmanned autonomous vehicle.

It is yet another aspect of the present invention to provide a method of controlling an unmanned autonomous vehicle that may include: acquiring, by an acquiring device, a boarding intention of a passenger who intends to board the unmanned autonomous vehicle by receiving a wireless communication signal generated in response to the boarding intention of the passenger; determining, by a controller, that the passenger indicates the boarding intention of the unmanned autonomous vehicle when a predetermined indication of the boarding intention is included in a photographed image; and determining, by the controller, whether to stop the unmanned autonomous vehicle at the bus stop based on the acquired boarding intention of the unmanned autonomous vehicle.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a view illustrating an unmanned autonomous driving system according to an exemplary embodiment of the present invention;

FIGS. 2A-2B are views illustrating a control system of an unmanned autonomous vehicle according to the exemplary embodiment of the present invention;

FIGS. 3A-3C are views illustrating an indication and recognition of an intention to board the unmanned autonomous vehicle according to the exemplary embodiment of the present invention;

FIGS. 4A-4B are views illustrating an indication and recognition of an intention to board the unmanned autonomous vehicle according to another exemplary embodiment of the present invention;

FIGS. 5A-5C are views illustrating an indication and recognition of an intention to board the unmanned autonomous vehicle according to another exemplary embodiment of the present invention; and

FIGS. 6A-6C are views illustrating an indication and recognition of an intention to board the unmanned autonomous vehicle according to another exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In the following description, ‘passenger,’ ‘boarded passenger’ and ‘waiting passenger’ are defined as follows. The term ‘passenger’ includes both a person getting off a vehicle and a person getting on a vehicle. The term ‘boarded passenger’ refers to a person who is already boarded on or boarding a vehicle. The term ‘waiting passenger’ refers to a person waiting at a bus stop to board a vehicle. In addition, ‘to board’ or ‘boarding’ means that a passenger gets on or gets into a vehicle.

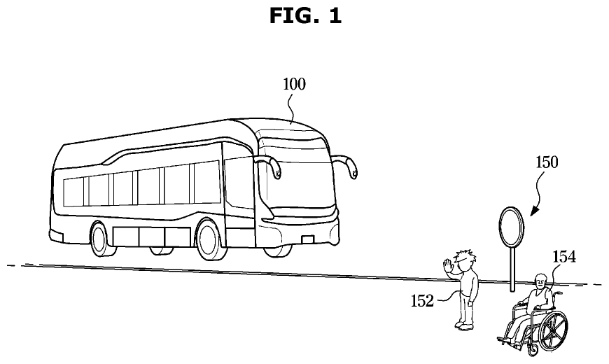

FIG. 1 is a view illustrating an unmanned autonomous driving system according to an exemplary embodiment of the present invention. The exemplary embodiment shown in FIGS. 1 to 6C shows an unmanned autonomous bus as an example of an unmanned autonomous vehicle. However, the exemplary embodiment of the present invention is not limited to the unmanned autonomous bus, but may be applied to all unmanned autonomous vehicles including an unmanned autonomous cargo vehicle, an unmanned autonomous taxi, etc.

As shown in FIG. 1, an unmanned autonomous vehicle 100 according to an exemplary embodiment of the present invention passes through a plurality of predetermined stops while moving along a predetermined route between a starting point and a destination. At each of the plurality of stops, some passengers may get on or get off the unmanned autonomous vehicle 100. At some stops there may be no passengers getting on or getting off.

When the passengers already on board the unmanned autonomous vehicle 100 want to get off at a bus stop 150, an intention to get off may be expressed by pressing a button for getting off inside the unmanned autonomous vehicle 100. The unmanned autonomous vehicle 100 may thus be configured to stop at the stop 150 in response to the intention of the passengers to get off to allow the passengers to get off. In contrast, in the conventional unmanned autonomous driving system, there was no way for passengers waiting at the stop to communicate an intention to board the conventional unmanned autonomous vehicle.

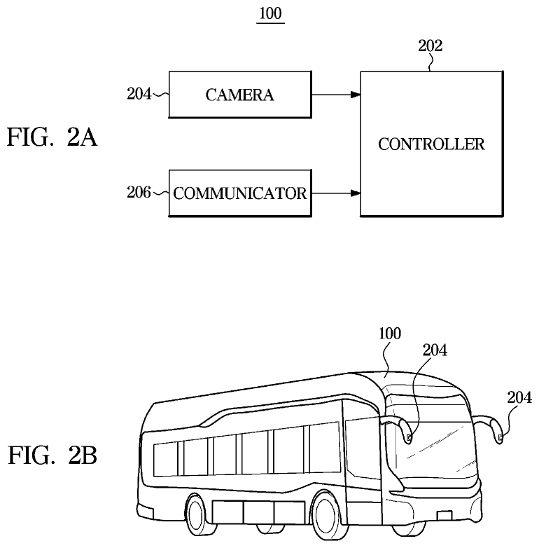

Accordingly, in the unmanned autonomous driving system according to an exemplary embodiment of the present invention, waiting passengers 152 and 154 waiting at the stop 150 may indicate (e.g., display or communicate) an intention to board the unmanned autonomous vehicle 100, to the unmanned autonomous vehicle 100. As a result, the convenience of the passengers using the unmanned autonomous vehicle 100 is improved. An apparatus and method for indicating the boarding intention of the unmanned autonomous driving system according to an exemplary embodiment of the present invention will be described in detail with reference to FIGS. 2A to 6C.

FIGS. 2A-2B are views illustrating a control system of an unmanned autonomous vehicle according to the exemplary embodiment of the present invention. As shown in FIGS. 2A-2B, the unmanned autonomous vehicle 100 according to the exemplary embodiment of the present disclosure may include a controller 202, a camera 204, and a communicator 206. The controller 202 may be configured to operate the other components within the vehicle 100. In the unmanned autonomous driving system according to an exemplary embodiment of the present invention, the camera 204 and the communicator 206 mounted on the unmanned autonomous vehicle 100 may be collecting devices configured to collect or obtain the intention to board from the waiting passengers 152 and 154 waiting at the stop 150.

The controller 202 may be configured to execute the overall operation of the unmanned autonomous vehicle 100. While the vehicle is being driven, the controller 202 may be configured to acquire and process external information to detect a surrounding environment, determine a driving route of the unmanned autonomous vehicle 100, and allow the unmanned autonomous vehicle 100 to operate independently using self-power. For this purpose, the controller 202, using precise maps, satellite navigation systems (GPS), and various sensors, may be configured to detect the surrounding environment and determine the route, and travel along the route by manipulating a steering wheel, accelerator, brake, etc., to implement various automatic control technologies such as distance keeping, lane departure warning, lane keeping assistance, rear/side warning, cruise control and automatic emergency braking.

The camera 204 may be configured to acquire an image (e.g., still image or video) by photographing a predetermined range in front of the unmanned autonomous vehicle 100. The image acquired through the camera 204 may be analyzed by the controller 202. The controller 202 may be configured to determine whether there are any of the waiting passengers 152 and 154 intending to board at the next stop 150 by analysis of the image. In response to determining that there are the waiting passengers 152 and 154 intending to board the unmanned autonomous vehicle 100 at the next stop 150, the controller 202 may be configured to stop the unmanned autonomous vehicle 100 at the next stop 150 to allow the waiting passengers 152 and 154 to board the unmanned autonomous vehicle 100.

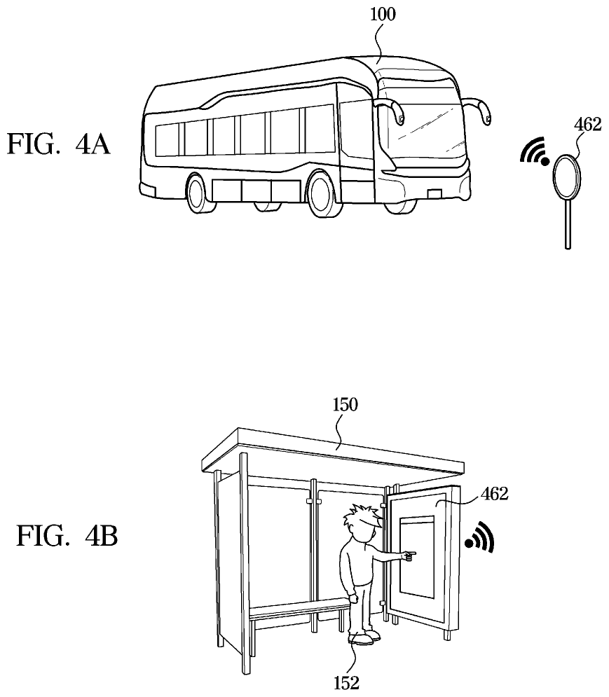

In FIG. 2A, the communicator 206 may be configured to receive a wireless communication signal transmitted from a passenger intending to board the unmanned autonomous vehicle 100, and transmit the received wireless communication signal to the controller 202. In other words, when the waiting passengers 152 and 154 at the bus stop 150 indicate the intention to board the unmanned autonomous vehicle 100 using a boarding intention indicating device (see FIGS. 4A to 6C) provided for each of the bus stops 150, the wireless communication signal may be generated and transmitted to the communicator 206 of the unmanned autonomous vehicle 100.

The communicator 206 of the unmanned autonomous vehicle 100 may be configured to receive the wireless communication signal transmitted from the boarding intention indicating device of the bus stop 150 and transmit the wireless communication signal to the controller 202. The controller 202 may then be configured to determine whether there are any of the waiting passengers 152 and 154 intending to board the unmanned autonomous vehicle 100 at the next bus stop 150 by analyzing the wireless communication signal received via the communicator 206. In response to determining that there are the waiting passengers 152 and 154 intending to board the unmanned autonomous vehicle 100 at the next bus stop 150, the controller 202 may be configured to stop the unmanned autonomous vehicle 100 at the next bus stop 150 to allow the waiting passengers 152 and 154 to board the unmanned autonomous vehicle 100.

FIG. 2B is an example of an installation position of the camera 204 of the unmanned autonomous vehicle 100. As shown in FIG. 2B, the camera 204 may be installed in an outside mirror of the unmanned autonomous vehicle 100. The installation position of the camera 204 is not limited to the outside mirror, and the installation position of the camera 204 may be any other position capable of photographing a predetermined range in front of the unmanned autonomous vehicle 100. For example, the camera 204 may be installed in a front bumper of the unmanned autonomous vehicle 100 or proximate to a room mirror or on a dashboard inside of the unmanned autonomous vehicle 100.

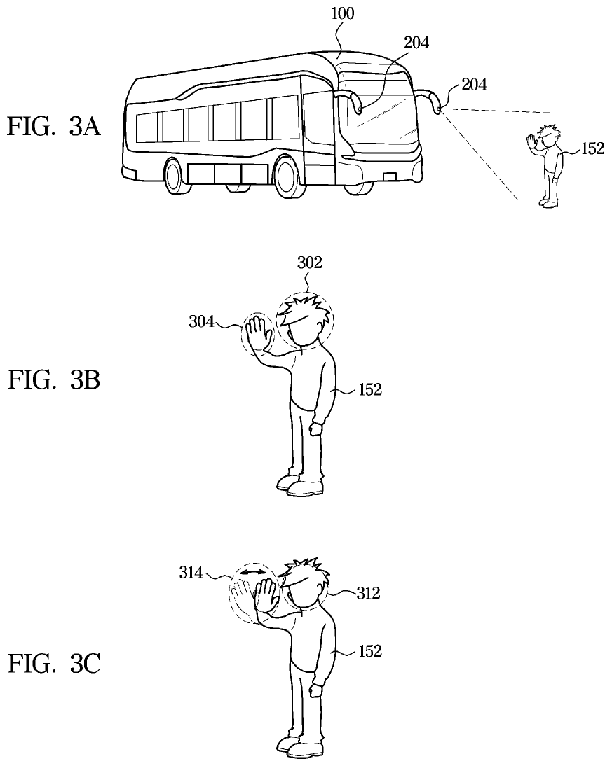

FIGS. 3A-3C are views illustrating an indication and recognition of an intention to board the unmanned autonomous vehicle according to the exemplary embodiment of the present invention. In the exemplary embodiment shown in FIG. 3A, the unmanned autonomous vehicle 100 may be configured to photograph a gesture made by the waiting passenger 152 of the bus stop 150 with the camera 204, and analyze the captured image to recognize or detect the intention to board of the waiting passenger 152.

FIG. 3A is a view illustrating a scene of photographing the waiting passenger at the bus stop 150 using the camera 204 of the unmanned autonomous vehicle 100. As shown in FIG. 3A, when the waiting passenger 152 at the next bus stop 150 is photographed using the camera 204 of the unmanned autonomous vehicle 100, the controller 202 may be configured to determine whether the waiting passenger 152 is making a predetermined gesture to indicate the boarding intention by analysis of the photographed image. If the waiting passenger 152 indicates the boarding intention by making the predetermined gesture, the controller 202 of the unmanned autonomous vehicle 100 may be configured to stop the unmanned autonomous vehicle 100 at the next bus stop 150 to allow the waiting passenger 152 to board the unmanned autonomous vehicle 100.

FIG. 3B is a view illustrating an example of the predetermined gesture for indicating the boarding intention. As shown in FIG. 3B, the waiting passenger 152 may show the boarding intention of the unmanned autonomous vehicle 100 by facing a palm of the waiting passenger 152 to the unmanned autonomous vehicle 100 while the waiting passenger 152 is looking at the unmanned autonomous vehicle 100. The controller 202 of the unmanned autonomous vehicle 100 may be configured to verify the direction of a face 302 and a palm 304 of the waiting passenger 152 from the image of the waiting passenger 152. If the face 302 and the palm 304 of the waiting passenger 152 face the unmanned autonomous vehicle 100, the controller 202 may be configured to detect that the waiting passenger 152 indicates the boarding intention. The controller 202 may thus be configured to stop the unmanned autonomous vehicle 100 at the next bus stop 150 in response to the boarding intention of the waiting passenger 152 to allow the waiting passenger 152 to board the unmanned autonomous vehicle 100.

FIG. 3C is a view illustrating another example of the predetermined gesture for indicating the boarding intention. As shown in FIG. 3C, the waiting passenger 152 may show the boarding intention of the unmanned autonomous vehicle 100 by facing the palm of the waiting passenger 152 to the unmanned autonomous vehicle 100 and shaking a hand of the waiting passenger 152 for a predetermined number of times while the waiting passenger 152 is looking at the unmanned autonomous vehicle 100. The controller 202 of the unmanned autonomous vehicle 100 may be configured to verfiy the direction of the face 302 and the palm 304 of the waiting passenger 152 and the hand shaking of the waiting passenger 152 from the image of the waiting passenger 152. If the face 302 and the palm 304 of the waiting passenger 152 face the unmanned autonomous vehicle 100 and the hand of the waiting passenger 152 is shaking for the predetermined number of times, the controller 202 may be configured to detect that the waiting passenger 152 indicates the boarding intention. The controller 202 may thus be configured to stop the unmanned autonomous vehicle 100 at the next bus stop 150 in response to the boarding intention of the waiting passenger 152 to allow the waiting passenger 152 to board the unmanned autonomous vehicle 100.

Gestures for indicating the boarding intention are not limited to those shown in FIGS. 3B and 3C, and various other gestures using the body of the waiting passenger 152 may be used to indicate the boarding intention. In particular, a gesture for the traffic vulnerable is set to be relatively simpler to identify than a gesture for the general public. As a result, when the traffic vulnerable may be boarding, the unmanned autonomous vehicle 100 may prepare a convenient boarding environment for the traffic vulnerable. For example, the traffic vulnerable shakes a hand only two times and the general public shakes their hand four times, thereby distinguishing the gesture of the traffic vulnerable from the general public.

When the traffic vulnerable indicates the boarding intention at the bus stop 150, the controller 202 of the unmanned autonomous vehicle 100 may be configured to stop the unmanned autonomous vehicle 100 at the bus stop 150 and create a convenient boarding environment. For example, when the waiting passenger 154 in a wheelchair shows the intention to board, the controller 202 may be configured to prepare traffic vulnerable assistance equipment (e.g., a ramp or a lifting device) of the unmanned autonomous vehicle 100. The waiting passenger 154 in the wheelchair is considered to be able to more easily and conveniently board the unmanned autonomous vehicle 100. Particularly, the traffic vulnerable may include a person with a disability, a person using a wheelchair or crutches, a pregnant woman, an elderly person who has difficulty in mobility, a young child, or the like.

FIGS. 4A-4B are views illustrating an indication and recognition of an intention to board the unmanned autonomous vehicle according to another exemplary embodiment of the present invention. As shown in FIG. 4A, when the waiting passenger 152 inputs the boarding intention via a ‘smart traffic sign 462,’ which is a terminal provided at the bus stop 150, the boarding intention of the waiting passenger 152 may be transmitted to the unmanned autonomous vehicle 100 via wireless communication. The controller 202 of the unmanned autonomous vehicle 100 may be configured to receive the boarding intention of the waiting passenger 152 transmitted from the smart traffic sign 462 of the bus stop 150 via the communicator 206, and the controller 202 may be configured to stop the unmanned autonomous vehicle 100 at the next bus stop 150 in response to the boarding intention of the waiting passenger 152 to allow the waiting passenger 152 to board the unmanned autonomous vehicle 100.

As shown in FIG. 4B, the smart traffic sign 462 is a combination of a touch display capable of touch input and a communication module capable of wireless communication. The smart traffic sign 462 and the unmanned autonomous vehicle 100 may be configured to perform wireless communication with each other. In other words, in the exemplary embodiment of the present invention, the terminal named the smart traffic sign 462 may be provided at the bus stop 150 at which the unmanned autonomous vehicle 100 stops, the waiting passenger 152 may search for various information related to the unmanned autonomous vehicle 100, and the waiting passenger 152 may input the boarding intention of the unmanned autonomous vehicle 100.

The waiting passenger 152 may select an intention to board the unmanned autonomous vehicle 100 and set the boarding intention through the touch display of the smart traffic sign 462. When the indication (setting) of the boarding intention of the waiting passenger 152 is completed, the boarding intention of the waiting passenger 152 may be transmitted to the unmanned autonomous vehicle 100 via wireless communication, and the controller 202 of the unmanned autonomous vehicle 100 may be configured to verify the boarding intention of the waiting passenger 152. The smart traffic sign 462 allows the waiting passenger 152 to search for information related to the unmanned autonomous vehicle 100 that the waiting passenger 152 intends to board, and the boarding intention may be input based on the search result. For this purpose, the touch display of the smart traffic sign 462 may be configured to display information such as a specified number, a driving route, and a current location of the unmanned autonomous vehicle 100. In addition, the smart traffic sign 462 may provide a user interface that allows the waiting passenger 152 to search for various information of the unmanned autonomous vehicle 100 by inputting a specific route or a specific number and to input the boarding intention.

In addition, the smart traffic sign 462 may allow the traffic vulnerable to indicate that they are the traffic vulnerable when setting the boarding intention. When the traffic vulnerable indicates the boarding intention at the bus stop 150, the controller 202 of the unmanned autonomous vehicle 100 may be configured to stop the unmanned autonomous vehicle 100 at the bus stop 150 and create a convenient boarding environment. For example, when the waiting passenger 154 in the wheelchair shows the intention to board, the controller 202 may be configured to prepare the traffic vulnerable assistance equipment (e.g., a ramp or a lifting device) of the unmanned autonomous vehicle 100. The waiting passenger 154 in the wheelchair may be considered to be able to more easily and conveniently board the unmanned autonomous vehicle 100. In particular, the traffic vulnerable may include a person with a disability, a person using a wheelchair or crutches, a pregnant woman, an elderly person who has difficulty in mobility, a young child, or the like.

The smart traffic sign 462 as shown in FIGS. 4A-4B allows the waiting passenger 152 to correctly designate the specific unmanned autonomous vehicle 100 they intend to board and transfer the boarding intention. Accordingly, the unmanned autonomous vehicle 100 may be configured to more correctly determine whether to stop at the bus stop 150 or pass the bus stop 150 without stopping.

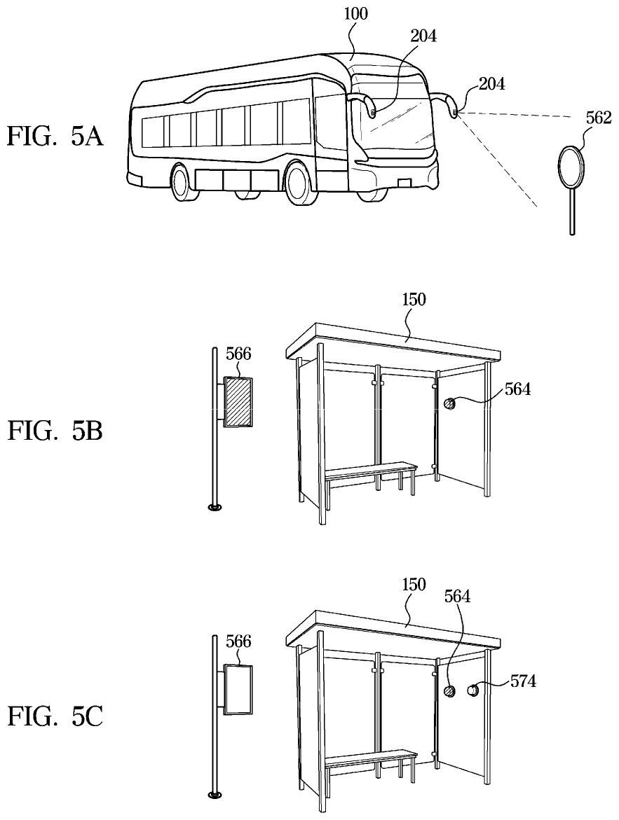

FIGS. 5A-5C are views illustrating an indication and recognition of an intention to board the unmanned autonomous vehicle according to another exemplary embodiment of the present invention. FIG. 5A is a view illustrating a scene of photographing a ‘smart traffic sign 562,’ which is a display provided at the bus stop 150, using the camera 204 of the unmanned autonomous vehicle 100. As shown in FIG. 5A, the controller 202 of the unmanned autonomous vehicle 100 may be configured to photograph the smart traffic sign 562 of the next bus stop 150 using the camera 204, and verify the boarding intention of the waiting passenger 152 by a lighting color of the smart traffic sign 562. When the boarding intention of the waiting passenger 152 is verified from the lighting color of the smart traffic sign 562 of the bus stop 150, the controller 202 may be configured to stop the unmanned autonomous vehicle 100 at the next bus stop 150 to allow the waiting passenger 152 to board the unmanned autonomous vehicle 100.

As shown in FIG. 5B, the smart traffic sign 562 according to another exemplary embodiment may include a boarding button 564 and an indicator 566. The boarding button 564 and the indicator 566 may be linked to communicate with each other and thus, the indicator 566 may be turned on by pressing the boarding button 564. The waiting passenger 152 may indicate the boarding intention by pressing the boarding button 564 to turn on (light on) the indicator 566. The controller 202 of the unmanned autonomous vehicle 100 may be configured to verify an on/off state of the indicator 566 from an image of the indicator 566 photographed using the camera 204. If the indicator 566 is turned on, the controller 202 may be configured to verify that the waiting passenger 152 indicates the boarding intention. The controller 202 may thus be configured to stop the unmanned autonomous vehicle 100 at the next bus stop 150 in response to the boarding intention of the waiting passenger to allow the waiting passenger 152 to board the unmanned autonomous vehicle 100.

A holding time of a turn on state of the indicator 566 according to the boarding intention of the waiting passenger 152 is limited to the time when the unmanned autonomous vehicle 100 that is traveling toward the bus stop 150 arrives at the bus stop 150. In other words, when the unmanned autonomous vehicle 100 traveling toward the bus stop 150 arrives at the bus stop 150, the indicator 566 may be turned off. As another case, a lighting state of the indicator 566 may be maintained for a predetermined period of time. For example, while the indicator 566 is turned on by pressing the boarding button 564 to indicate that the waiting passenger 152 intends to board, the indicator 566 may be turned off after a predetermined time elapses, regardless of whether the unmanned autonomous vehicle 100 arrives.

FIG. 5C is an exemplary embodiment for enabling the traffic vulnerable to indicate the boarding intention. As shown in FIG. 5C, the boarding button 564 for the general public and a boarding button 574 for the traffic vulnerable are distinguished, and the lighting color for the general public and the lighting color for the traffic vulnerable are also distinguished. By the distinction, it may be possible to verify whether the traffic vulnerable is included among the waiting passengers 152 waiting to board.

When the traffic vulnerable indicates the boarding intention at the bus stop 150, the controller 202 of the unmanned autonomous vehicle 100 may be configured to stop the unmanned autonomous vehicle 100 at the bus stop 150 and create a convenient boarding environment. For example, when the waiting passenger 154 in the wheelchair shows the intention to board, the controller 202 may be configured to prepare the traffic vulnerable assistance equipment (e.g., a ramp or a lifting device) of the unmanned autonomous vehicle 100. The waiting passenger 154 in the wheelchair may be considered to be able to more easily and conveniently board the unmanned autonomous vehicle 100. In particular, the traffic vulnerable may include a person with a disability, a person using a wheelchair or crutches, a pregnant woman, an elderly person who has difficulty in mobility, a young child, or the like.

The indication and recognition of the boarding intention using the boarding buttons 564 and 574 and the indicator 566 as shown in FIGS. 5A-5C provide an advantage that may be easily implemented at a lower cost. In other words, since only the boarding buttons 564 and 574 and the indicator 566 are required for each of the bus stops 150, the boarding buttons 564 and 574 and the indicator 566 may be implemented at a much lower cost than when using the touch display and a wireless communication network.

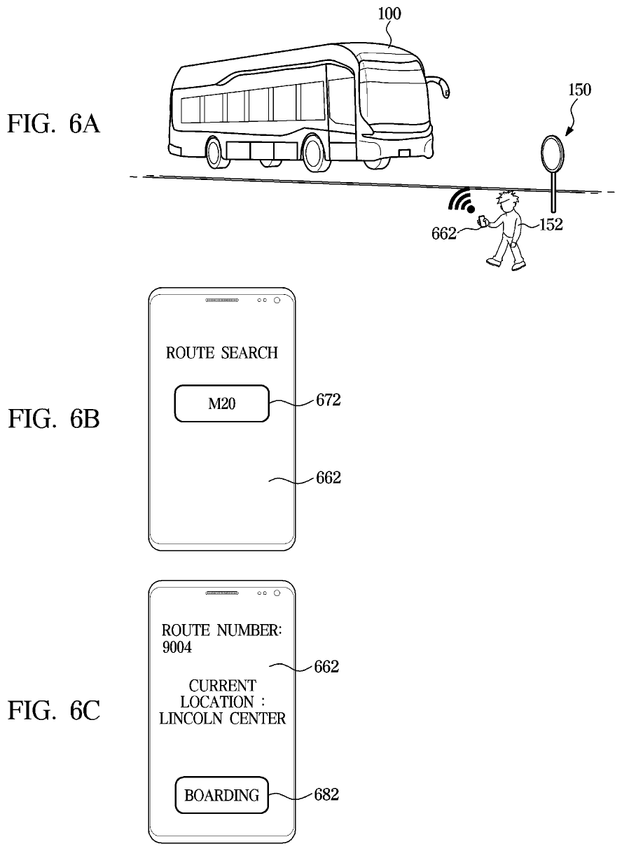

FIGS. 6A-6C are views illustrating an indication and recognition of an intention to board the unmanned autonomous vehicle according to another exemplary embodiment of the present invention. As shown in FIG. 6A, when the waiting passenger 152 inputs the boarding intention via a vehicle management application of a mobile device 662 of the waiting passenger 152, the boarding intention of the waiting passenger 152 may be wirelessly transmitted to the unmanned autonomous vehicle 100 via wireless communication. The controller 202 of the unmanned autonomous vehicle 100 may be configured to receive the boarding intention of the waiting passenger 152 transmitted from the mobile device 662 of the waiting passenger 152 via the communicator 206, and stop the unmanned autonomous vehicle 100 at the next bus stop 150 in response to the boarding intention of the waiting passenger 152 to allow the waiting passenger 152 to board the unmanned autonomous vehicle 100.

FIG. 6B is a diagram showing an example of an execution screen of the vehicle management application of the mobile device 662. As shown in FIG. 6B, when the vehicle management application is executed on the mobile device 662, a search box 672 to input a search keyword for a route to be boarded may be displayed on the screen.

As shown in FIG. 6C, by entering ‘M20’ into the search box 672 to search for route M20, information regarding the route M20 and a boarding button 682 may be displayed on the screen. The boarding button 682 is for input (set) of the boarding intention. The information of the current state of the route M20 may include a current position of the vehicle. The waiting passenger 152 may input (set) the boarding intention of the unmanned autonomous vehicle 100 of the route M20 currently located at ‘Lincoln Center’ bus stop by touching the boarding button 682. When the setting of the boarding intention of the waiting passenger 152 is completed, the boarding intention may be transmitted to the unmanned autonomous vehicle 100 and the controller 202 of the unmanned autonomous vehicle 100 may be configured to verify the boarding intention of the waiting passenger 152.

As in the above-described other exemplary embodiments, the exemplary embodiment of FIGS. 6A-6C may allow the traffic vulnerable to indicate that they are the traffic vulnerable when setting the boarding intention. When the traffic vulnerable shows the boarding intention at the bus stop 150, the controller 202 of the unmanned autonomous vehicle 100 may be configured to stop the unmanned autonomous vehicle 100 at the bus stop 150 and create a convenient boarding environment. For example, when the waiting passenger 154 in the wheelchair shows the intention to board, the controller 202 may be configured to prepare the traffic vulnerable assistance equipment (e.g., a ramp or a lifting device) of the unmanned autonomous vehicle 100. The waiting passenger 154 in the wheelchair may be considered to be able to more easily and conveniently board the unmanned autonomous vehicle 100. Particularly, the traffic vulnerable may include a person with a disability, a person using a wheelchair or crutches, a pregnant woman, an elderly person who has difficulty in mobility, a young child, or the like.

Through the indication of the boarding intention using the mobile device 662 as shown in FIGS. 6A-6C, the waiting passenger 152 may designate the specific unmanned autonomous vehicle 100 they desire to board and transfer the boarding intention. Accordingly, the unmanned autonomous vehicle 100 may be configured to correctly determine whether to stop at the bus stop 150 or pass the bus stop 150 without stopping. In addition, since the waiting passenger 152 uses the mobile device 662, there is no need to install an additional touch display or indicator at each bus stop, thereby greatly reducing the cost required for infrastructure construction.

The above description of the present disclosure is for illustrative purposes, and a person having ordinary skilled in the art should appreciate that other specific modifications may be easily made without departing from the technical spirit or essential features of the present disclosure. Therefore, the above exemplary embodiments should be regarded as illustrative rather than limitative in all aspects. The scope of the disclosure is not to be limited by the detailed description set forth above, but by the accompanying claims of the present disclosure, and it should also be understood that all changes or modifications derived from the definitions and scope of the claims and their equivalents fall within the scope of the present disclosure.

What is claimed is:

1. A method of controlling an unmanned autonomous vehicle, comprising:
acquiring, by an acquiring device, a boarding intention of a passenger who intends to board the unmanned autonomous vehicle; and
determining, by a controller, whether to stop the unmanned autonomous vehicle at a bus stop based on the acquired boarding intention of the unmanned autonomous vehicle.

2. The method of claim 1, wherein the acquiring of the boarding intention includes:
photographing the bus stop using a camera; and
determining, by the controller, that the passenger indicates the boarding intention of the unmanned autonomous vehicle when a predetermined indication of the boarding intention is included in a photographed image.

3. The method of claim 2, wherein the predetermined indication of the boarding intention includes a predetermined gesture that indicates the boarding intention and the unmanned autonomous vehicle is configured to verify the boarding intention by photographing a gesture of the passenger using the camera.

4. The method of claim 2, wherein the predetermined indication of the boarding intention includes operation of a button provided at the bus stop to turn on an indicator linked to the button and the unmanned autonomous vehicle is configured to photograph the indicator using the camera and verify the boarding intention based on whether the indicator is turned on.

5. The method of claim 1, wherein the acquiring of the boarding intention includes:
receiving, by the controller, a wireless communication signal generated in response to the boarding intention of the passenger; and
determining, by the controller, that the passenger indicates the boarding intention of the unmanned autonomous vehicle when a predetermined indication of the boarding intention is included in the wireless communication signal.

6. The method of claim 5, wherein the indication of the boarding intention of the passenger includes an input of the boarding intention through a touch display provided at the bus stop and the unmanned autonomous vehicle is configured to verify the boarding intention by receiving the input of the touch display via wireless communication.

7. The method of claim 5, wherein the indication of the boarding intention of the passenger includes an input of the boarding intention via a mobile device and the unmanned autonomous vehicle is configured to verify the boarding intention by receiving the input of the mobile device via wireless communication.

8. An unmanned autonomous vehicle, comprising:
an acquiring device configured to acquire a boarding intention of a passenger intending to board the unmanned autonomous vehicle; and
a controller configured to determine whether to stop the unmanned autonomous vehicle at a bus stop based on the acquired boarding intention of the unmanned autonomous vehicle.

9. The unmanned autonomous vehicle of claim 8, wherein the acquiring device includes a camera configured to photograph a next bus stop and the controller is configured to determine that the boarding intention of the passenger when a predetermined indication of the boarding intention is included in a photographed image.

10. The unmanned autonomous vehicle of claim 9, wherein the predetermined indication of the boarding intention includes a predetermined gesture to indicate the boarding intention and the unmanned autonomous vehicle is configured to verify the boarding intention by photographing a gesture of the passenger using the camera.

11. The unmanned autonomous vehicle of claim 9, wherein the predetermined indication of the boarding intention includes an operation of a button provided at the bus stop to turn on an indicator linked to the button and the unmanned autonomous vehicle is configured to photograph the indicator by the camera and verify the boarding intention based on whether the indicator is turned on.

12. The unmanned autonomous vehicle of claim 8, wherein the acquiring of the boarding intention includes:
receiving, by the controller, a wireless communication signal generated in response to the boarding intention of the passenger; and
determining, by the controller, the boarding intention of the passenger when a predetermined indication of the boarding intention is included in the wireless communication signal.

13. The unmanned autonomous vehicle of claim 12, wherein the indication of the boarding intention of the passenger includes an input of the boarding intention through a touch display provided at the bus stop and the unmanned autonomous vehicle is configured to verify the boarding intention by receiving the input of the touch display via wireless communication.

14. The unmanned autonomous vehicle of claim 12, wherein the indication of the boarding intention of the passenger includes an input of the boarding intention via a mobile device and the unmanned autonomous vehicle is configured to verify the boarding intention by receiving the input of the mobile device via wireless communication.

15. A method of controlling an unmanned autonomous vehicle, comprising:
acquiring, by an acquiring device, a boarding intention of a passenger who intends to board the unmanned autonomous vehicle by photographing a bus stop using a camera;
determining, by a controller, that the passenger indicates the boarding intention of the unmanned autonomous vehicle when a predetermined indication of the boarding intention is included in a photographed image; and
determining, by the controller, whether to stop the unmanned autonomous vehicle at the bus stop based on the acquired boarding intention of the unmanned autonomous vehicle.

16. A method of controlling an unmanned autonomous vehicle, comprising:
acquiring, by an acquiring device, a boarding intention of a passenger who intends to board the unmanned autonomous vehicle by receiving a wireless communication signal generated in response to the boarding intention of the passenger;
determining, by a controller, that the passenger indicates the boarding intention of the unmanned autonomous vehicle when a predetermined indication of the boarding intention is included in a photographed image; and
determining, by the controller, whether to stop the unmanned autonomous vehicle at the bus stop based on the acquired boarding intention of the unmanned autonomous vehicle.
